(19) United States
(12) Patent Application Publication
(10) Pub. No.: US 2025/0309437 A1
(43) Pub. Date: Oct. 2, 2025

(54) BATTERY MODULE

(71) Applicant: HONDA MOTOR CO., LTD., Tokyo (JP)

(72) Inventors: Wataru SHIMIZU, Saitama (JP); Masataka FURUYAMA, Saitama (JP); Shodai KATO, Saitama (JP)

(21) Appl. No.: 19/061,942

(22) Filed: Feb. 24, 2025

(30) Foreign Application Priority Data
Mar. 28, 2024 (JP) 2024-053323

(51) Int. Cl. H01M 50/242; H01M 50/211; H01M 50/291

(52) U.S. Cl. CPC H01M 50/242; H01M 50/211; H01M 50/291

(57) ABSTRACT

Provided is a battery module in which the entirety of each of surfaces of battery cells is uniformly pressurized and no load is applied due to expansion at the time of charge. A battery module includes: a pressurization container filled with a pressure medium; a cell stack including a plurality of battery cells that are stacked, the cell stack being housed in the pressurization container; and holders respectively interposed between the battery cells stacked and between an outermost one of the battery cells and an inner wall of the pressurization container, the holders maintaining the cell stack in a stacked state, each of the holders being constituted by a porous body having an elasticity.

This application is based on and claims the benefit of priority from Japanese Patent Application No. 2024-053323, filed on 28 Mar. 2024, the content of which is incorporated herein by reference.

### BACKGROUND OF THE INVENTION

### Field of the Invention

The present invention relates to a battery module.

### Related Art

A battery module is widely known in which a plurality of laminated batteries each sealed in a laminate film are stacked and pressure-restrained from upper and lower surfaces in the stacking direction, whereby resistance distribution is narrowed and reaction is made uniform in the electrode. However, the pressure-restraining method, in which the batteries are restrained uniaxially from the upper and lower surfaces, achieves insufficient uniformity of the reaction, resulting in that the battery module does not have satisfactory initial characteristics or durability, and further, the yield is lowered. In order to solve these problems, it is necessary to increase the pressure-restraining force of the battery module, which tends to lead to an increase in the size of the exterior body for restraint.

On the other hand, a liquid-immersion pressurization container that does not use such a restraining exterior body has been proposed (see Japanese Unexamined Patent Application (Translation of PCT Application), Publication No. 2022-511920). According to Japanese Unexamined Patent Application (Translation of PCT Application), Publication No. 2022-511920, pressurized oil and a pouch cell (laminated battery) are housed in a sealed pressurization container, and the pouch cell is maintained in a pressurized state by being surrounded by the pressurized oil, whereby a restraining pressure is applied not only uniaxially from the upper and lower surfaces but also omnidirectionally. A plurality of the pouch cells may be stacked to form a pouch cell sequence group.

Patent Document 1: Japanese Unexamined Patent Application (Translation of PCT Application), Publication No. 2022-511920

### SUMMARY OF THE INVENTION

In a case where a plurality of pouch cells are stacked, there may be a disadvantage that the pouch cells are displaced from each other because the thicknesses of the batteries change depending on a state of charge. To address this disadvantage, a method is known in which holders are interposed between the pouch cells so that the pouch cells are held and prevented from moving. Therefore, in a case where a solid-state battery module in which pouch cells are stacked is housed in the liquid-immersion pressurization container disclosed in Japanese Unexamined Patent Application (Translation of PCT Application), Publication No. 2022-511920, the configuration of these holders is an issue.

For example, in a case where a soft holder is used, the holder itself is crushed by the internal pressure of the container, and a gap is formed between the holder and the laminated batteries (pouch cells), thereby giving rise to a problem that the laminated batteries are displaced from each other. Conversely, in a case where a hard holder is used, the holder comes into tight contact with the surfaces of the laminated batteries, which prevents the pressurized oil as a pressure medium from coming into contact with the laminated batteries, thereby giving rise to a problem that the pressure medium cannot apply a pressure to the laminated batteries. In addition, since the hard holder, which is not deformable, has a problem in that a load is applied to the laminated batteries, the holder, and the pressurization container when the batteries expand due to charge.

An object of the present invention is to provide a battery module in which the entirety of each of surfaces of battery cells is uniformly pressurized and no load is applied due to expansion at the time of charge.

A first aspect of the present invention is directed to a battery module (e.g., a battery module 10, 10B to be described later) including: a pressurization container (e.g., a pressurization container 1 to be described later) filled with a pressure medium (e.g., a liquid 2 to be described later); a cell stack (e.g., a laminated battery stack 30 to be described later) including a plurality of battery cells (e.g., laminated batteries 3 to be described later) that are stacked, the cell stack being housed in the pressurization container; and holders (e.g., holders 4 to be described later) respectively interposed between the battery cells stacked and between an outermost one of the battery cells and an inner wall of the pressurization container, the holders maintaining the cell stack in a stacked state. Each of the holders is constituted by a porous body having an elasticity.

The feature in which the cell stack is housed in the pressurization container filled with the pressure medium makes it possible to uniformly pressurize the entirety of each of the surfaces of the battery cells. The feature in which the holders are respectively interposed between the battery cells and between the outermost one of the battery cells and the inner wall of the pressurization container makes it possible to reduce the likelihood of the battery cells being moved and displaced in a direction with a vector that is orthogonal to a stacking direction, whereby the cell stack can be maintained in the stacked state. In addition, the holders, each of which is a porous body having an elasticity, are compressed and extend following expansion and contraction of the battery cells when the thicknesses of the battery cells change at the time of charge and at the time of discharge, whereby the position of each of the battery cells does not change, the uniformity of the reaction of the battery module can be maintained, and the durability can also be improved. The holders having an elasticity make it possible to maintain uniform pressurization of the cell stack without applying a load to pressurization container, the cell stack, or the holders.

In the battery module according to a second aspect of the present invention, each of the holders is constituted by a porous body having open pores filled with the pressure medium.

Since the holders are each a structure with the open pores including through holes, the through holes are sufficiently impregnated with the pressure medium, thereby making it possible to maintain uniform pressurization of the cell stack in a more preferred state.

In the battery module according to a third aspect of the present invention, each of the holders has a porosity of 20% or more and 50% or less.

Setting the porosity of the holders to 20% or more and 50% or less makes the holders sufficiently elastic to be able to flexibly deform following expansion and contraction of the battery cells.

In the battery module according to a fourth aspect of the present invention, each of the holders has a compressibility of 20% or more and 50% or less.

Setting the compressibility of the holders to 20% or more and 50% or less prevents the holders from deforming in response to application of a pressure by the pressure medium, but allows the holders to flexibly deform following the expansion of the cell batteries.

In the battery module according to a fifth aspect of the present invention, each of the holders has a holding force of 0.2 MPa or more and 0.5 MPa or less.

Setting the holding force of the holders to 0.2 MPa or more and 0.5 MPa or less makes it possible to reduce the likelihood of the battery cells being moved and displaced in a direction opposite to a compressing direction, whereby the cell stack can be maintained in the stacked state.

In the battery module according to a sixth aspect of the present invention, the holders are disposed to cover edges of the battery cells. By disposing the holders to cover the edges of the battery cells, the edges of the battery cells are reliably held by the holders, thereby making it possible to reduce the likelihood of the battery cells being moved and displaced in a direction orthogonal to the stacking direction.

In the battery module according to a seventh aspect of the present invention, each of the holders is a porous body including a partition wall having a circular cross-sectional shape.

By forming the partition wall constituting each holder to have a circular cross-sectional shape, the porous body enables the holder to be impregnated with a sufficient amount of the pressure medium.

In the battery module according to an eighth aspect of the present invention, each of the holders is a porous body including a partition wall having a corrugated cross-sectional shape.

By forming the partition wall constituting each holder to have a corrugated cross-sectional shape, the porous body enables the holder to be impregnated with a sufficient amount of the pressure medium.

In the battery module according to a ninth aspect of the present invention, each of the battery cells is an all-solid-state battery cell.

For all-solid-state batteries, an important issue is to maintain uniform pressure from a pressure medium, and therefore, a preferred effect can be obtained by employing the present invention.

The present invention provides the battery module which includes the cell stack including stacked battery cells and in which the entirety of each of the surfaces of the battery cells is uniformly pressurized by the pressure medium filling the pressurization container. The battery module of the present invention further includes the holders capable of maintaining the cell stack in a stacked state without allowing the battery cells to change in position, and makes it possible to maintain uniform pressurization of the cell stack without applying a load to the pressurization container, the cell stack, or the holders.

### BRIEF DESCRIPTION OF THE DRAWINGS

FIG. 1 is a schematic diagram illustrating a battery module according to a first embodiment;

FIG. 2 is an enlarged schematic view illustrating the battery module according to the first embodiment;

FIG. 3 is an enlarged schematic view illustrating a state in which the laminated batteries of FIG. 2 have expanded; and

FIG. 4 is an enlarged schematic view illustrating a battery module according to a second embodiment.

### DETAILED DESCRIPTION OF THE INVENTION

### First Embodiment

A first embodiment of the present invention will be described below in detail with reference to the drawings.

In the drawings illustrating the present invention, predetermined three directions orthogonal to each other are represented in an X-Y-Z orthogonal coordinate system. The “X direction” indicates a width direction of a solid-state battery module 10, the “Y direction” indicates a length direction of the solid-state battery module 10, and the “Z direction” indicates a height direction of the solid-state battery module 10. In addition, an “L direction” indicates a stacking direction in which laminated batteries 3 are stacked.

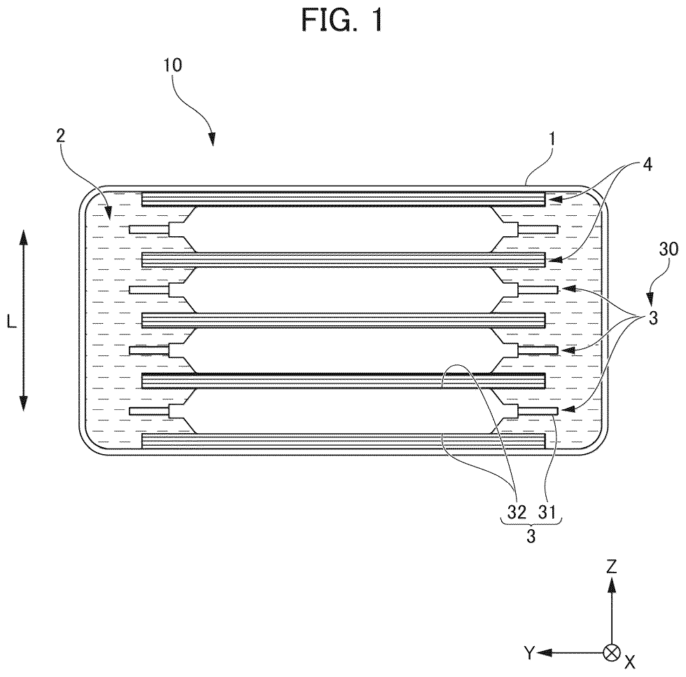

FIG. 1 is a schematic diagram illustrating the whole battery module 10 according to the first embodiment as viewed in the X direction. As illustrated in FIG. 1, the solid-state battery module 10 includes a pressurization container 1, a liquid 2, a laminated battery stack 30, and holders 4. The pressurization container 1 is used with its body and lid (not shown) sealed, such that a sealed internal space is formed therein. The pressurization container 1 may be made of any material as long as the liquid 2 can be maintained in a pressurized state, and examples of the material include a metal such as aluminum, stainless steel, etc., resin, and the like.

The liquid 2 is filled in the pressurization container 1 and pressurized by a pressurizer (not shown). As the pressurizer, a pressurizing pump can be used, for example, but the pressurizer of the present invention is not limited thereto. The liquid 2 may be any liquid as long as it can transmit pressure, and examples thereof include hydraulic oil such as petroleum-based hydraulic oil, flame-retardant hydraulic oil, etc. The liquid 2 acts on the laminated battery stack 30 as a pressure medium.

The laminated battery stack 30 includes laminated batteries 3 that are stacked. The laminated battery stack 30 is housed in a sealed state in the pressurization container 1, and is immersed in and pressurized by the liquid 2. Each laminated battery 3 has an electrode laminate (not shown) including a positive electrode layer, a solid electrolyte layer, and a negative electrode layer, and is sealed in a laminate film. Each laminated battery 3 includes current collecting tabs 31 and contact surfaces 32. The pair of current collecting tabs 31 are led out from both ends of the laminated battery 3 in the Y direction. The contact surfaces 32 are orthogonal to the L direction and are in contact with the holders 4.

The plurality of holders 4, each of which is a face plate, are arranged at intervals in the sealed internal space of the pressurization container 1 and are immersed in and pressurized by the liquid 2. As illustrated in FIG. 1, the holders 4 are respectively interposed between the stacked laminated batteries 3 and between each outermost laminated battery 3 and the inner wall of the pressurization container 1. The holders 4 are capable of maintaining the laminated battery stack 30 in a stacked state and reducing the likelihood of the laminated batteries 3 being moved and displaced in a direction orthogonal to the L direction.

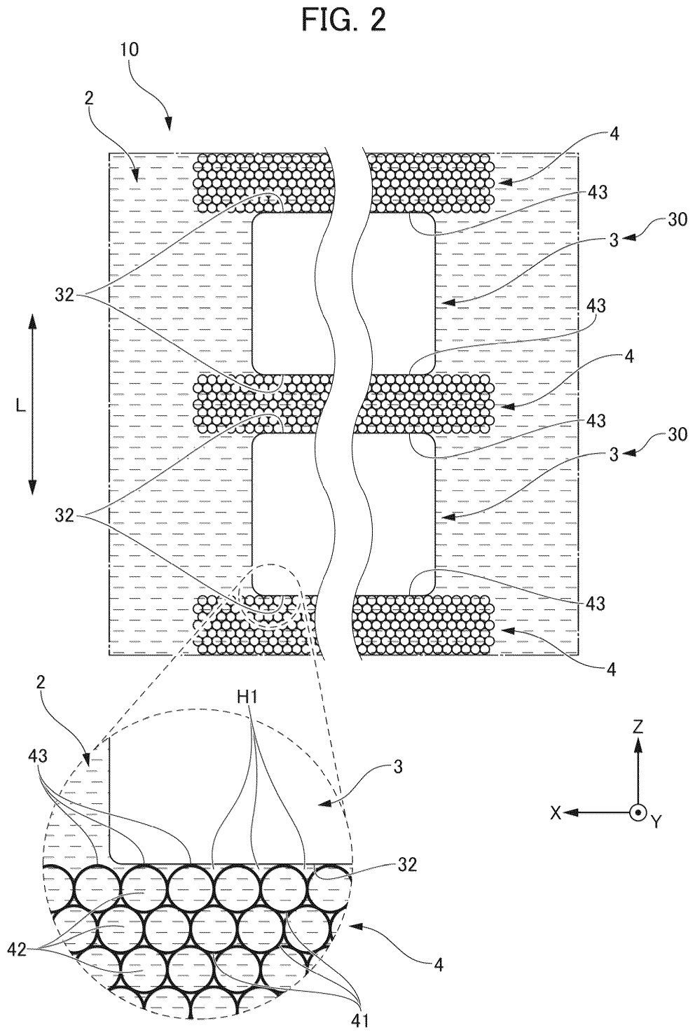

FIG. 2 is a partially enlarged schematic view illustrating the battery module 10 according to the first embodiment as viewed in the Y direction. As illustrated in FIG. 2, each holder 4 includes a base material 41, cavities 42, and contact surfaces 43. The base material 41 constitutes a body of the holder 4, and includes an assembly of cylindrical shapes. That is, each holder 4 is a porous body that includes partition walls having a circular cross-sectional shape. The plurality of cylindrical shapes does not have to have the same size, and each holder 4 may include a plurality of cylindrical shapes of different sizes in accordance with the laminated batteries 3. This configuration makes the holders 4 elastic.

The holder 4 applies a holding force of 0.2 MPa or more and 0.5 MPa or less in the stacking direction of the laminated battery stack 30. The holding force can be determined by measuring a stress strain of the holder 4. Alternatively, the holding force can be derived from a relationship between a value y of the holding force indicated by a pressure measuring element interposed between the laminated batteries and a value x of a compressibility of the holder 4. In this case, a tactile sensor or pressure sensitive paper can be used as the pressure measuring element. The compressibility is determined by dividing a thickness of the holder 4 interposed between the laminated batteries by a thickness of the holder 4 before being interposed between the laminated batteries. By virtue of the holding force within the above-described range, the holders 4 are capable of reliably holding the laminated batteries 3.

The base material 41 is formed of a polymer resin or a metal, and has a compressibility of 5% or less with respect to application of a pressure of 1 MPa. The compressibility can be determined by measuring a stress strain of the base material 41. By virtue of the compressibility within the above-described range, the base material 41 does not deform in response to application of the pressure of the liquid 2, and can reliably maintain the shape of the holder 4.

The cavities 42 are through holes in the cylindrical shapes of the base material 41, and accordingly, each holder 4 includes open pores. The cavities 42 are impregnated with the liquid 2, and each holder 4 has a porosity of 20% or more and 50% or less. The porosity can be determined from a weight per volume of the holder 4 and a density of the base material 41. The configuration described above makes the holders 4 sufficiently elastic to be able to flexibly deform following expansion and contraction of the laminated batteries 3.

By virtue of the effects of the base material 41 and the cavities 42 described above, each holder 4 has a compressibility of 20% or more and 50% or less with respect to application of a pressure of 1 MPa. Setting the compressibility within this range prevents each holder 4 from deforming in response to application of a pressure by the liquid 2, but allows each holder 4 to flexibly deform following the expansion of the laminated batteries 3.

The contact surfaces 43 are where the holder 4 comes into contact with the laminated batteries 3, and are orthogonal to the L direction. As illustrated in FIGS. 1 and 2, the edges of each contact surface 32 of the laminated batteries 3 are covered with the contact surface 43 of the holder 4, and the contact surface 43 of the holder 4 has a larger area than the contact surface 32 of the laminated battery 3. In other words, the holders 4 are arranged so as to cover the edges of the laminated batteries 3. Due to this configuration, the edges of the laminated batteries 3 are reliably held by the holders 4, thereby making it possible to reduce the likelihood of the laminated batteries 3 being moved and displaced in a direction orthogonal to the L direction.

As illustrated in FIG. 2, a plurality of hollow portions H1 are formed between each contact surface 32 of the laminated battery 3 and the adjacent base material 41. Due to this configuration, the liquid 2 filling the pressurization container 1 is in contact with each contact surfaces 32 of the laminated batteries 3 via the hollow portions H1, whereby the contact surfaces 32 of the laminated batteries 3 can be uniformly pressurized by the liquid 2 in the L direction.

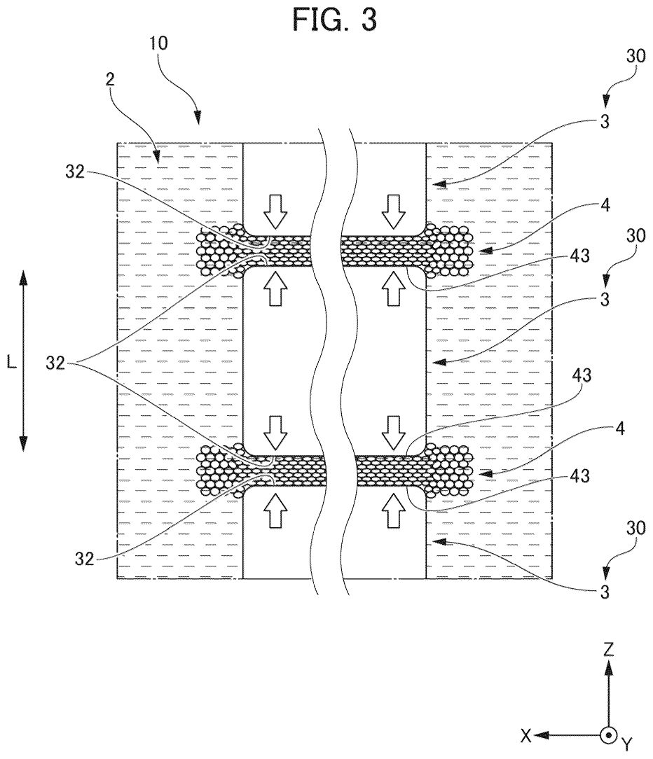

FIG. 3 is a partially enlarged schematic view illustrating a state in which the laminated batteries 3 of the battery module 10 have expanded, as viewed in the Y direction. Since the thickness of each laminated battery 3 changes depending on a state of charge, the laminated battery 3 has a characteristic that its thickness increases in the L direction as a result of repetition of charge as illustrated in FIG. 3. Even when the laminated batteries 3 expand, the holders 4 can be flexibly compressed in the L direction to follow the expansion of the laminated batteries 3. Conversely, when the laminated batteries 3 contract due to discharge, the holder 4 can extend in the L direction to follow the laminated batteries 3.

Due to the above configuration, even when the laminated batteries 3 expand and contract, the holders 4 can follow the laminated batteries 3 and maintain the cavities 42. As a result, the liquid 2 with which the cavities 42 are impregnated maintains the laminated battery stack 30 in a uniformly pressurized state.

Furthermore, the flexible deformation of the holders 4 makes the laminated batteries 3 less likely to be displaced in—a direction with a vector that is orthogonal to the L direction, and the laminated batteries 3 are held in the pressurization container 1 without allowing the current collecting tabs 31 to change in position. Thus, the uniformity of the reaction in the solid-state battery module 10 can be maintained not only at the beginning of life (BOL) but also at the end of life (EOL), and the durability of the solid-state battery module 10 can also be improved.

The present embodiment exerts the following effects.

The solid-state battery module 10 according to the present embodiment includes the pressurization container 1 filled with the liquid 2, the laminated battery stack 30, and the holders 4, and the laminated battery stack 30 is immersed in and pressurized by the liquid 2. The holders 4 are each an elastic porous structure body constituted by cylindrical shapes, and are respectively interposed between the laminated batteries 3 and between the set of laminated batteries 3 and the inner wall of the pressurization container 1.

Due to this configuration, the edges of the laminated batteries 3 are reliably held by the holders 4, thereby making it possible to reduce the likelihood of the laminated batteries 3 being moved and displaced in a direction orthogonal to the L direction. Furthermore, the holders 4 are flexibly deformable in accordance with the expansion and contraction of the laminated batteries 3, thereby making it possible to reduce the likelihood of the laminated batteries 3 being displaced in a direction with a vector that is orthogonal to the L direction. As a result, the laminated batteries 3 can be held under application of a uniform pressure for the period of time from the BOL to the EOL, and the current collecting tabs 31 can be maintained in position inside the pressurization container 1.

In addition, using the holders 4 in the solid-state battery module 10 according to the present embodiment enables the liquid 2 to apply a uniform pressure to the entirety of each of the surfaces of the laminated batteries 3, thereby making it possible to maintain uniform pressurization of the laminated battery stack 30 without applying a load to the laminated batteries 3, the holders 4, or the pressurization container 1 even when the laminated batteries 3 expand.

In the foregoing, a preferred embodiment of the present invention has been described. However, the present invention is not limited to the above-described embodiment, and can be appropriately modified within the scope of the spirit of the present invention.

For example, the laminated battery 3 is not limited to an all-solid-state battery, and may be a battery including a liquid electrolyte. The battery used in the present invention is not limited to the laminated battery, and may be a battery including an electrode laminate and a molded container in which the electrode laminate is enclosed.

The holder 4 of the present invention may be made of any material as long as it is a porous structure satisfying the compressibility with respect to application of a pressure. For example, a sponge having a porous structure may be used as the holder 4. The holders 4 of the present embodiment have a structure with open pores, but may have a structure with closed pores as long as the holders 4 have a sufficient elasticity to follow expansion and contraction of the laminated batteries 3.

### Second Embodiment

Next, a second embodiment of the present invention will be described in detail with reference to the drawings. The second embodiment differs from the first embodiment in the shape of holders 4B. Since the other components of the second embodiment are the same as those of the first embodiment, the description thereof will be omitted. A solid-state battery module 10B of the present embodiment includes a pressurization container 1, a liquid 2, a laminated battery stack 30, and the holders 4B.

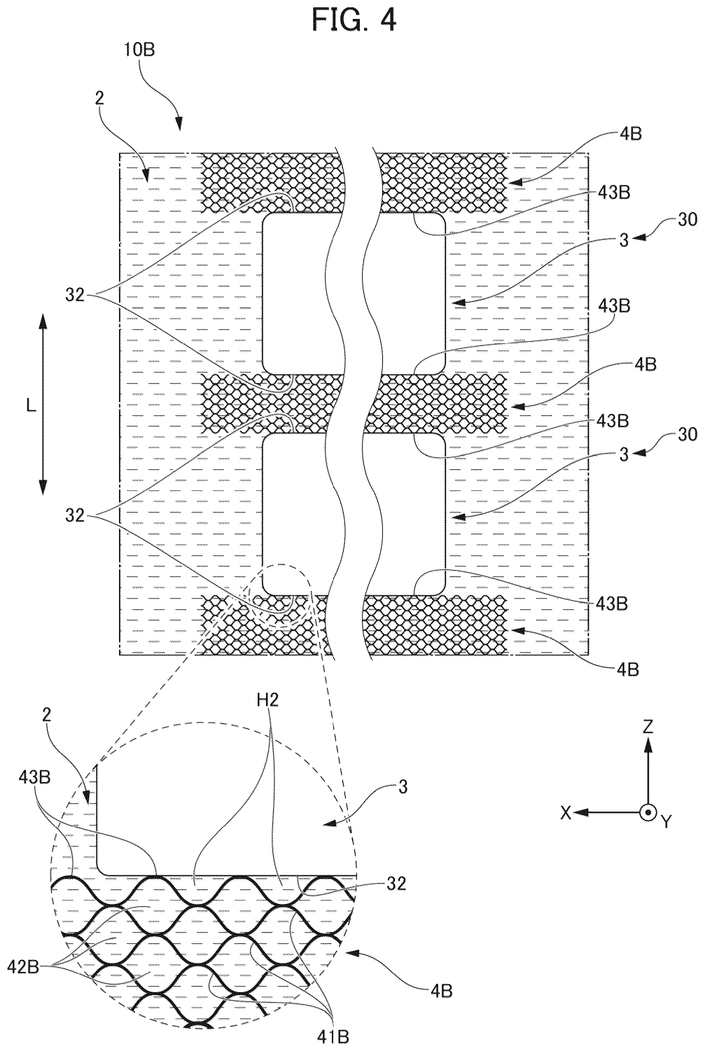

FIG. 4 is a partially enlarged schematic view illustrating the battery module 10B according to the second embodiment as viewed in the Y direction. As illustrated in FIG. 4, each holder 4B includes a base material 41B, cavities 42B, and contact surfaces 43B. The base material 41B constitutes a body of the holder 4B, and includes an assembly of corrugated shapes. That is, each holder 4B is a porous body including partition walls having a corrugated cross-sectional shape. The repetition interval and height of the corrugations can be appropriately changed according to the laminated batteries 3. For example, the holder 4B may include an assembly of corrugated shapes having different heights.

The base material 41B is made of a polymer resin or a metal, and has a compressibility of 5% or less with respect to application of a pressure of 1 MPa. The method of measuring a compressibility and the method of measuring a porosity are the same as those described in the first embodiment, and the description thereof will be omitted. By virtue of the compressibility within the above-described range, the base material 41B does not deform in response to the application of a pressure by the liquid 2, and can reliably maintain the shape of the holder 4B.

The cavities 42B are through holes formed by stacking the corrugated shapes of the base material 41B, and accordingly, each holder 4B includes open pores. Due to this configuration, the cavities 42B are impregnated with the liquid 2, and the holders 4B have a porosity of 20% or more and 50% or less. The cavities 42B make the holders 4B so elastic to be able to flexibly deform according to expansion of the laminated batteries 3.

By virtue of the effects of the base material 41B and the cavities 42B described above, each holder 4B has a compressibility of 20% or more and 50% or less with respect to application of a pressure of 1 MPa. Setting the compressibility within this range prevents each holder 4B from deforming in response to application of a pressure by the liquid 2, but allows each holder 4B to flexibly deform following the expansion of the laminated batteries 3.

The contact surfaces 43B are where the holder 4B comes into contact with the laminated batteries 3, and are orthogonal to the L direction. As illustrated in FIG. 4, the edges of each contact surface 32 of the laminated batteries 3 are covered with the contact surface 43B of the holder 4B, and the contact surface 43B of the holder 4B has a larger area than the contact surface 32 of the laminated battery 3. Due to this configuration, the edges of the laminated batteries 3 are reliably held by the holders 4B, thereby making it possible to reduce the likelihood of the laminated batteries 3 being moved and displaced in a direction orthogonal to the L direction.

As illustrated in FIG. 4, a plurality of hollow portions H2 are formed between each contact surface 32 of the laminated battery 3 and the adjacent base material 41B. Due to this configuration, the liquid 2 filling the pressurization container 1 is in contact with each contact surfaces 32 of the laminated batteries 3 via the hollow portions H2, whereby the contact surfaces 32 of the laminated batteries 3 can be uniformly pressurized by the liquid 2 in the L direction.

Even when the laminated batteries 3 expand and contract, the corrugated shapes are compressed in accordance with the deformation of the holders 4B, whereby the holders 4B can be flexibly compressed or extend in the L direction following the laminated batteries 3. Thus, even when the thicknesses of the laminated batteries 3 change, the holders 4B can maintain the cavities 42B, and the liquid 2 with which the cavities 42B are impregnated maintains the laminated battery stack 30 in a uniformly pressurized state.

Since the second embodiment exerts the same effects as those of the first embodiment, the description thereof will be omitted.

In the foregoing, a preferred embodiment of the present invention has been described. However, the present invention is not limited to the above-described embodiment, and can be appropriately modified within the scope of the spirit of the present invention.

As in the first embodiment, the laminated battery 3 is not limited to an all-solid-state battery, and may be a battery including a liquid electrolyte. The battery used in the present invention is not limited to the laminated battery, and may be a battery including an electrode laminate and a molded container in which the electrode laminate is enclosed.

The holders 4B of the present embodiment have a structure with open pores, but may have a structure with closed pores as long as the holders 4B have a sufficient elasticity to follow expansion and contraction of the laminated batteries 3.

### EXPLANATION OF REFERENCE NUMERALS

1: Pressurization container
2: Liquid (pressure medium)
3: Laminated battery (battery cell)
4, 4B: Holder
10, 10B: Battery module
30: Laminated battery stack (cell stack)
42, 42B: Cavity (pore)

What is claimed is:

1. A battery module comprising:
a pressurization container filled with a pressure medium;
a cell stack including a plurality of battery cells that are stacked, the cell stack being housed in the pressurization container; and
holders respectively interposed between the battery cells stacked and between an outermost one of the battery cells and an inner wall of the pressurization container, the holders maintaining the cell stack in a stacked state,
each of the holders being constituted by a porous body having an elasticity.

2. The battery module according to claim 1, wherein
each of the holders is constituted by a porous body having open pores filled with the pressure medium.

3. The battery module according to claim 1, wherein
each of the holders has a porosity of 20% or more and 50% or less.

4. The battery module according to claim 1, wherein
each of the holders has a compressibility of 20% or more and 50% or less.

5. The battery module according to claim 1, wherein
each of the holders has a holding force of 0.2 MPa or more and 0.5 MPa or less.

6. The battery module according to claim 1, wherein
the holders are disposed to cover edges of the battery cells.

7. The battery module according to claim 1, wherein
each of the holders is a porous body including a partition wall having a circular cross-sectional shape.

8. The battery module according to claim 1, wherein
each of the holders is a porous body including a partition wall having a corrugated cross-sectional shape.

9. The battery module of claim 1, wherein
each of the battery cells is an all-solid-state battery cell.
